(19) United States
(12) Patent Application Publication
(10) Pub. No.: US 2016/0295116 A1
(43) Pub. Date: Oct. 6, 2016

(54) MULTI-FUNCTIONAL DISPLAYS

(71) Applicant: SEMICONDUCTOR COMPONENTS INDUSTRIES, LLC, Phoenix, AZ (US)

(72) Inventor: Yuen-Shung CHIEH, Sunnyvale, CA (US)

(73) Assignee: SEMICONDUCTOR COMPONENTS INDUSTRIES, LLC, Phoenix, AZ (US)

(21) Appl. No.: 14/675,863

(22) Filed: Apr. 1, 2015

(51) Int. Cl. H04N 5/232; H04N 5/225; H04N 5/33

(52) U.S. Cl. CPC H04N 5/23293; H04N 5/33; H04N 5/2256; H04N 5/2252

(57) ABSTRACT

A display module with infra-red (IR) light emitting capabilities is disclosed. A display module in a housing may have IR light emitting capabilities. The display module may include a transmissive display element. IR light emitted by an IR illuminant formed at an edge of the display module housing may be optically coupled to the display element using a dispersive element. An IR shutter may be interposed between the dispersive element and the display element. Control circuitry may configure the IR shutter to filter IR light in selected regions of the IR shutter. An image of a scene may be captured while the scene is illuminated by IR light emitted through the IR filter and the display element using an image sensor. The image sensor may be external to the display module housing, or it may be formed inside the display module housing and receive light incident on the display element.

### BACKGROUND

This relates generally to imaging systems, and more particularly to imaging systems with displays that are used to emit structured light.

Electronic devices such as cellular telephones, cameras, and computers often include imaging systems that include digital image sensors for capturing images. Image sensors may be formed having a two-dimensional array of image pixels that convert incident photons (light) into electrical signals. Electronic devices often include displays for displaying captured image data.

Electronic devices may be used for interactive gaming or communication applications. In traditional electronic devices used for video-conferencing applications, a user's eyes are directed toward a display. Cameras used to capture an image of a user may do so without having depth and/or reflectance profiles of the user, leading to low-quality images. Furthermore, image sensors used to capture images of a user are often at a different height of the device than the eye line of the user, leading to unattractive captured images where the user's eyes are not facing forward.

Traditional means of emitting structured light in electronic devices involve producing structured light from a source that is above or below a user's eye line. Consequently, certain features of a user or scene that are shadowed when illuminated from above or below may not be able to be mapped with structured light.

It would therefore be desirable to be able to provide imaging systems with improved structured light emitting and image capturing capabilities.

### BRIEF DESCRIPTION OF THE DRAWINGS

FIG. 1 is a diagram of an illustrative system that includes an imaging system and a host subsystem in accordance with an embodiment of the present invention.

FIG. 2 is a diagram of an illustrative cross-sectional view of a transmissive display module with structured light emitting capabilities in accordance with an embodiment of the present invention.

FIG. 3 is a diagram of illustrative structured light patterns that can be emitted from a display module in accordance with an embodiment of the present invention.

FIG. 4 is a diagram of an illustrative cross-sectional view of a non-transmissive display module with structured light emitting capabilities in accordance with an embodiment of the present invention.

FIG. 5 is a flow chart of illustrative steps that can be used to operate a display module of the type shown in FIGS. 2 and 4 in accordance with an embodiment of the present invention.

FIG. 6 is a diagram of an illustrative cross-sectional view of an integrated camera display module with image capturing and structured light emitting capabilities in accordance with an embodiment of the present invention.

FIG. 7 is a flow chart of illustrative steps that may be used to operate an integrated camera display such as an integrated camera display module of the type shown in FIG. 6 in accordance with an embodiment of the present invention.

### DETAILED DESCRIPTION

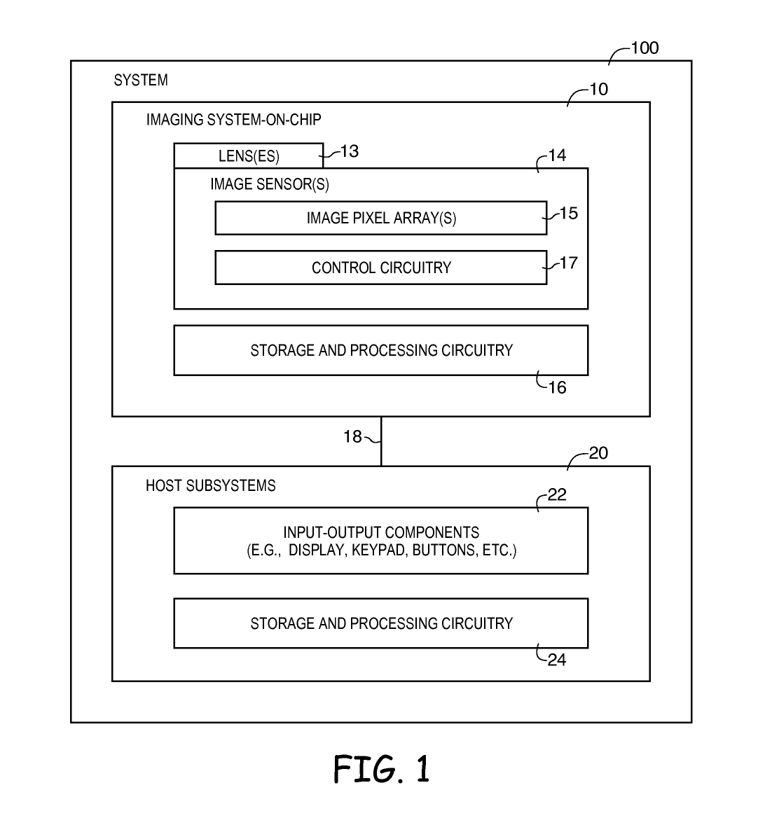

FIG. 1 is a diagram of an illustrative system including an imaging system for capturing images. System 100 of FIG. 1 may be a vehicle safety system (e.g., a rear-view camera or other vehicle safety system), a surveillance system, an electronic device such as a camera, a cellular telephone, a video camera, or any other desired electronic device that captures digital image data.

As shown in FIG. 1, system 100 may include an imaging system such as imaging system 10 and host subsystems such as host subsystem 20. Imaging system 10 may be an imaging system-on-chip that is implemented on a single silicon image sensor integrated circuit die. Imaging system 10 may include one or more image sensors 14 and one or more associated lenses 13. Lenses 13 in imaging system 10 may, as examples, include a single wide angle lens or M*N individual lenses arranged in an M×N array. Individual image sensors 14 may be arranged as a corresponding single image sensor or a corresponding M×N image sensor array (as examples). The values of M and N may each be equal to or greater than one, may each be equal to or greater than two, may exceed 10, or may have any other suitable values.

Each image sensor in imaging system 10 may be identical or there may be different types of image sensors in a given image sensor array integrated circuit. As one example, each image sensor may be a Video Graphics Array (VGA) sensor with a resolution of 480×640 image sensor pixels (as an example). Other arrangements of image sensor pixels may also be used for the image sensors if desired. For example, images sensors with greater than VGA resolution (e.g., high-definition image sensors), less than VGA resolution and/or image sensor arrays in which the image sensors are not all identical may be used.

During image capture operations, each lens 13 may focus light onto an associated image sensor 14. Image sensor 14 may include one or more arrays of photosensitive elements such as image pixel array(s) 15. Photosensitive elements (image pixels) such as photodiodes on arrays 15 may convert the light into electric charge. Image sensor 14 may also include control circuitry 17. Control circuitry 17 may include bias circuitry (e.g., source follower load circuits), sample and hold circuitry, correlated double sampling (CDS) circuitry, amplifier circuitry, analog-to-digital (ADC) converter circuitry, data output circuitry, memory (e.g., buffer circuitry), address circuitry, and other circuitry for operating the image pixels of image pixel array(s) 15 and converting electric charges into digital image data. Control circuitry 17 may include, for example, pixel row control circuitry coupled to arrays 15 via row control lines and column control and readout circuitry coupled to arrays 15 via column readout and control lines.

Still and video image data from imaging system 10 may be provided to storage and processing circuitry 16. Storage and processing circuitry 16 may include volatile and/or nonvolatile memory (e.g., random-access memory, flash memory, etc.). Storage and processing circuitry 16 may include microprocessors, microcontrollers, digital signal processors, application specific integrated circuits, Graphical Processing Units (GPUs), etc.

Image processing circuitry 16 may be used to store image data and perform image processing functions such as data formatting, adjusting white balance and exposure, implementing video image stabilization, face detection, image data write control, image data read control, output image pixel address to input image pixel address transformation, etc. Storage and processing circuitry 16 may include one or more conformal image buffers, a pixel transformation engine, a write control engine, a read control engine, an interpolation engine, a transformation engine, etc.

In one suitable arrangement, which is sometimes referred to as a system-on-chip (SOC) arrangement, image sensor(s) 14 and image processing circuitry 16 are implemented on a common semiconductor substrate (e.g., a common silicon image sensor integrated circuit die). If desired, image sensor(s) 14 and image processing circuitry 16 may be formed on separate semiconductor substrates. For example, sensor 14 and processing circuitry 16 may be formed on separate substrates that are stacked.

Imaging system 10 (e.g., processing circuitry 16) may convey acquired image data to host subsystem 20 over path 18. Host subsystem 20 may include a display for displaying image data captured by imaging system 10. Host subsystem 20 may include processing software for detecting objects in images, detecting motion of objects between image frames, determining distances to objects in images, filtering or otherwise processing images provided by imaging system 10. Host subsystem 20 may include a warning system configured to generate a warning (e.g., a warning light on an automobile dashboard, an audible warning or other warning) in the event objects in captured images are determined to be less than a predetermined distance from a vehicle in scenarios where system 100 is an automotive imaging system.

If desired, system 100 may provide a user with numerous high-level functions. In a computer or advanced cellular telephone, for example, a user may be provided with the ability to run user applications. To implement these functions, host subsystem 20 of system 100 may have input-output devices 22 and storage and processing circuitry 24. Input-output devices 22 may include keypads, input-output ports, joysticks, buttons, displays, etc. Displays in input-output devices 22 may include transmissive and non-transmissive display types. Transmissive displays may include LCD panels, and non-transmissive displays may include LED or OLED display panels. Storage and processing circuitry 24 may include volatile and nonvolatile memory (e.g., random-access memory, flash memory, hard drives, solid state drives, etc.). Storage and processing circuitry 24 may also include microprocessors, microcontrollers, digital signal processors, application specific integrated circuits, etc.

The image pixels of image pixels array(s) 15 may each include a photosensitive element such as photodiode, a positive power supply voltage terminal, a ground voltage terminal and additional circuitry such as reset transistors, source follower transistors, row-select transistors, charge storage nodes, etc. Image pixels in image pixel array(s) 15 may be three-transistor pixels, pin-photodiode pixels with four transistors each, global shutter pixels, time-of-flight pixels, or may have any other suitable photo-conversion architectures.

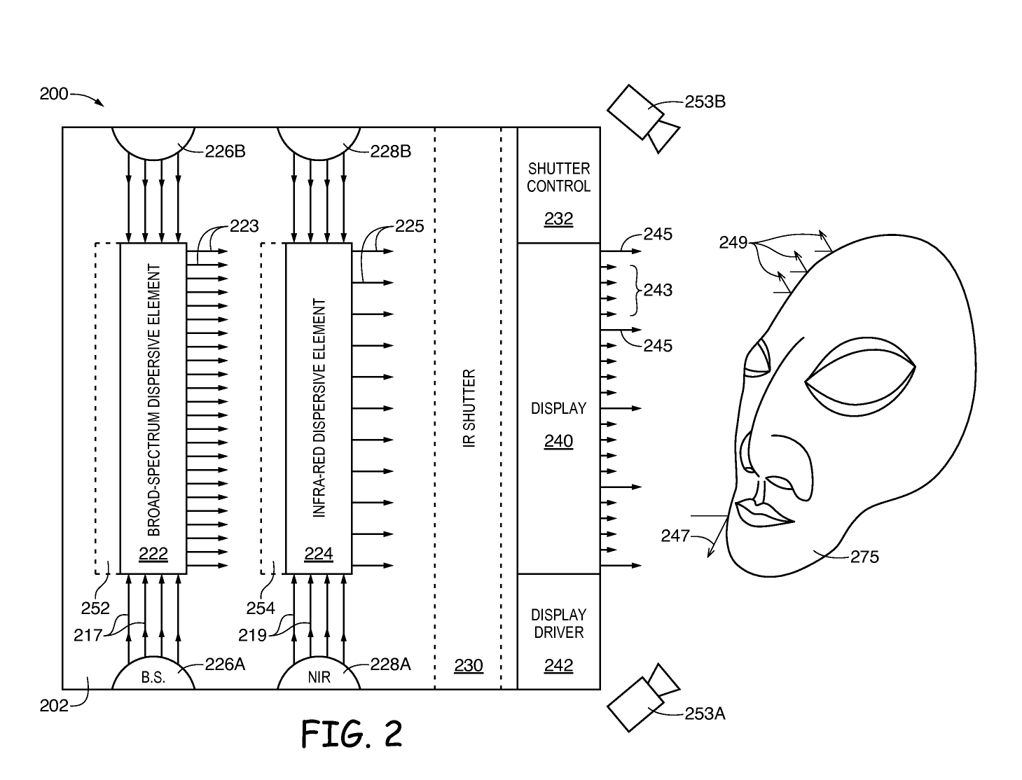

FIG. 2 illustrates a cross-sectional side view of structured light emitting display module 202 that may be used in a system 200 used to capture and characterize a scene. The outline of display module 202 may be a housing structure. Light emitting display 202 may include transmissive display element 240 such as a color or monochrome LCD display. Display 240 may be any type of transmissive display element. Display 240 may be able to display color images. Display 240 may be transparent to infrared (IR), or near-infrared light when displaying color patterns or forms. Alternatively, when color patterns or forms are displayed, display 240 may be opaque to IR or near-IR light.

Backlight illumination sources 226 and 228 may be formed behind display 240, at the edges of display module 202. A given backlight illumination source may be formed at one or more edges of display module 202 behind display 240. Broad spectrum illumination source 226A may be formed at a first edge of display module 202 behind display 240, whereas another broad spectrum illumination source 226B may be formed behind display 240 at a second edge of display module 202 that is opposite to the first edge. In embodiments of the present invention, a single broad spectrum illumination source such as 226A or 226B may be used, two broad spectrum illumination sources such as 226A and 226B may be used, or more than two broad spectrum illumination sources may be used. Broad spectrum illumination sources may be placed at opposing edges of a display module 202 or at adjacent edges of a display module 202.

Broad spectrum light 217 emitted from broad spectrum illumination sources 226 may enter a broad spectrum dispersive element 222. Dispersive elements, in the context of the below description of FIGS. 2-7 may include diffusion screens, mirrors, light dispersing balls, beam-splitters, or lenses.

Broad spectrum dispersive element 222 may include multiple light guide elements that optically couple input broad spectrum light 217 to output broad spectrum light 223 with a uniform luminance or intensity across the area of broad spectrum dispersive element 222 (e.g., that guide input broad spectrum light 217 into a perpendicular direction as output broad spectrum light 223 having a uniform intensity). Output broad spectrum light 223 may be of a uniform luminance and intensity. Broad spectrum dispersive element 222 may include additional light guide components 252 that help couple or direct input broad spectrum light 217 to output broad spectrum light 223.

Light 223 output from broad-spectrum dispersive element 222 may be used to illuminate the contents of dispersive display element in display 240. Broad spectrum illumination sources 226 may output light corresponding to the visible spectrum. Broad spectrum illumination sources 226 may produce broad spectrum light 217 which may correspond to white light. Output broad spectrum light 223 from broad spectrum dispersive element 222 may have substantially the same spectral characteristics as broad spectrum light 217 produced by broad spectrum illumination sources 226. Output broad spectrum light 223 may be white light, for example.

Output broad spectrum light 223 may pass through infra-red dispersive element 224 and IR shutter 230 (described below) to display 240. Broad-spectrum dispersive element 222 may be configured to output broad spectrum light 223 in an even and constant intensity and/or luminance when infrared dispersive element 224 minimally interferes with output broad spectrum light 223. When the interference of infrared dispersive element 224 with output broad spectrum light 223 is noticeable, output broad spectrum light 225 coupled via broad spectrum dispersive element 222 from input broad spectrum light 217 produced by broad spectrum illuminants 226 may have a non-uniform luminance and/or intensity across the area of broad spectrum dispersive element 222. The pattern or intensity of output broad spectrum light 223 may be unevenly distributed in a manner such that after passing through infra-red dispersive element 224, the broad spectrum light 223 may be of a uniform intensity and/or luminance in the area of display 240.

Output broad spectrum light 223 may serve as a backlight for transmissive display elements in display 240. Output visible light 243 may be color light that corresponds to output broad spectrum light 223 that has been filtered by transmissive display elements in display 240, such as LCD elements. Output visible light 243 may correspond to the light of colors and forms displayed on display 240.

Display module 202 may, if desired, include infrared (IR) or near infrared (NIR) illumination sources 228. In descriptions IR or NIR light being emitted or received from components in embodiments of the present invention, the terms IR and NIR may be used interchangeably and may refer to light in both IR and NIR spectra.

NIR illumination source 228A may be formed at a first edge of display module 202 behind display 240, whereas another NIR illumination source 228A may be formed behind display 240 at a second edge of display module 202 that is opposite the first edge. In embodiments of the present invention, a single NIR illumination source such as 228A or 228B may be used, two NIR illumination sources such as 228A and 228B may be used, or more than two broad NIR sources may be used. IR illumination sources may be formed at opposing edges of a display module 202 or at adjacent edges of a display module 202.

IR light 219 emitted from NIR illumination sources 228 may enter an IR dispersive element 224. IR dispersive element 224 may include a number of light guide elements that optically couple input IR light 219 to output IR light 225 with a uniform luminance or intensity across the area of dispersive element 224. Output IR light 225 may be of a uniform luminance and intensity. IR dispersive element 224 may include additional light guide components 254 that help couple or direct input IR light 219 to output NIR light 225. The luminance or intensity of output NIR light 225 may be less than or equal to the luminance or intensity of output broad spectrum light 225 from broad spectrum dispersive element 222. IR light 219 emitted from broad spectrum illumination sources 228 may be constantly emitted, or emitted periodically for finite intervals of time. Consequently, output IR light 225 may be constantly produced, or produced periodically for finite intervals of time.

As described above, IR dispersive element 224 may couple input IR light 219 to produce output IR light 225 that is more sparse, or less dense, than the output broad spectrum light 223 from broad spectrum dispersive element 222. However, output IR light 225 may have the same or greater intensity and/or luminance as output broad spectrum light 223.

Between infrared dispersive element 224 and display 240, an IR shutter 230 may be formed. IR shutter 230 may be transparent to broad spectrum light 223. IR shutter 230 may include an IR transmissive material that can be configured or controlled to reduce transmittance of IR light in certain regions. IR shutter 230 may be transparent to output broad spectrum light 223 and output IR light 225 in a default state. IR shutter 230 may be activated to selectively block IR light 225 from transmission through display 240 when NIR illumination sources 228 are turned on and emitting input IR light 219. Shutter control 232 may be used to control which regions of IR shutter 230 are configured to reduce transmittance, or block, output IR light 225. IR shutter 230 may have different regions that reduce transmittance of output IR light 225 by different degrees. For example, a first region of IR shutter 230 may reduce transmittance of output IR light 225 by 50 percent whereas a second region of IR shutter 230 may reduce transmittance of output IR light 225 by 25 percent. Alternatively, IR shutter 230 may have binary states for blocking or allowing transmission of output IR light 225 (i.e. 0 percent or 100 percent transmission, respectively). An idle state of IR shutter 230 may correspond to a state wherein all light (broad spectrum and IR) passes through IR shutter 230.

Display 240 may be transparent to IR light 225, and may only filter output broad spectrum light 223. In this way, display 240 may be used to display color forms illuminated by output broad spectrum light 223. Alternatively, regions of display 240 from which it is desired to output IR light 225 may be configured to be in an idle state (e.g., to allow transmission of output broad spectrum light 223) in the region, or configured to be in a dark state (e.g., to block transmission of output broad spectrum light 223) in the region. Display driver 242 may control multiple regions of transmissive display element 240 filter to filter particular colors from output broad spectrum output light 223. Display driver 242 may be a color or monochrome LCD display driver.

Light transmitted through display 240 may correspond to displayed visible light 243 and displayed IR light 245. Displayed IR light 245 may correspond to output IR light 225 filtered by IR shutter 230, and/or display 240. Displayed visible light 243 may correspond to output broad spectrum light 223 that may be dispersed by infrared dispersive element 224 and/or filtered by display 240. IR shutter 230 may be in an idle state when it is desired to display visible light 243 to a user 275. Alternatively, IR shutter 230 may be transparent to broad spectrum light while blocking IR light and be in any state when it is desired to display visible light 243 to a user 275.

Cameras 253 may be used to capture visible and/or IR light reflected in a scene that may include a user 275. Cameras 253 may include visible light time-of-flight pixels, IR time-of-flight pixels, pixels with color filter arrays, and pixels with IR filters. IR shutter 230 and/or IR dispersive element 224 may be configured to output structured IR light and to emit the structured IR light from a display 240. IR time-of-flight pixels and visible time-of-flight pixels in cameras 253 may be used to perform depth mapping functions on objects of a scene, including a user 275, using reflected visible light 249 and reflected structured IR light 247.

Cameras 253 may capture an IR image of the scene, and use reflections of the structured light emissions from display 240, such as reflected structured light 247, to perform depth mapping on objects in the scene, including user 275. Measuring reflected structured light 247 may also be used to determine optical and/or thermal characteristics of the scene, which can be used to optimize image capture and processing settings used to image a scene.

Cameras 253 may also capture standard visible light range images. Displayed visible light 243 may be incident on objects of the scene such as user 275. Displayed visible light 243 may be reflected as reflected visible light 249, and captured by cameras 253. As the system 200 knows the color of the displayed visible light 243, cameras 253 may capture the reflected visible light 249 corresponding to known displayed visible light 243, and may determine optical characteristics of the scene, such as optical characteristics of the skin of user 275. Optical characteristics of the scene derived from reflected visible light 249 may be used to optimize image capture and processing settings used to image a scene.

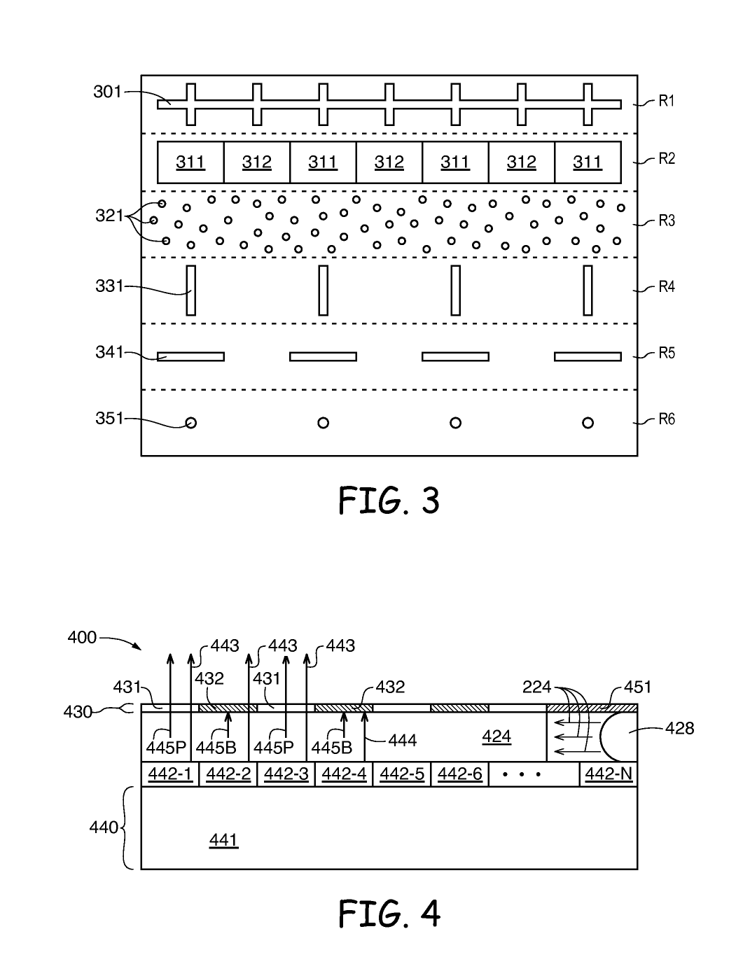

FIG. 3 illustrates patterns of structured IR light that may be emitted from display 240 by controlling IR shutter 230. Structured light may also be referred to as patterned light. Row R1 of FIG. 3 illustrates a grid pattern 301 of IR light. IR shutter 230 may be configured to allow transmission of IR light in a grid pattern 301 region, and block or attenuate transmission of IR light in other regions of row R1.

Row R2 of FIG. 3 illustrates a general periodic pattern that includes patterns 311 and 312. Pattern 311 may be an increasing gradient, where transmission of IR light is completely attenuated on the left side of pattern 311, transmission of IR light is completely unimpeded on the right side of pattern 311, and intermediate positions between the left and right side have respective decreasing levels of attenuation of IR light. Pattern 312 may be a decreasing gradient (e.g., a gradient opposite to that of portions 311). However, this example is merely illustrative. Patterns 311 and 312 may be any geometric pattern or any gradient pattern.

Row R3 of FIG. 3 illustrates a speckle pattern of random or pseudo random pattern of circles. IR shutter 230 may be configured to allow transmission of IR light in the region of speckle circles 321, and block or attenuate transmission of IR light in other regions of row R3.

Row R4 of FIG. 3 illustrates a vertical slit pattern. IR shutter 230 may be configured to allow transmission of IR light in the region of vertical slits 331, and block or attenuate transmission of IR light in other regions of row R3.

Row R5 of FIG. 3 illustrates a horizontal slit pattern. IR shutter 230 may be configured to allow transmission of IR light in the region of horizontal slits 341, and block or attenuate transmission of IR light in other regions of row R4.

Row R6 of FIG. 3 illustrates a dot pattern. IR shutter 230 may be configured to allow transmission of IR light in the region of dots 351, and block or attenuate transmission of IR light in other regions of row R5.

Patterns of rows R1-R6 may be used across the length of display 240, across a portion of the length of display 240, and in any desired combination. As an example, the pattern of row R1 may be displayed for a first length of IR shutter 230 corresponding to a first length of display 240, and the pattern of row R3 may be displayed for a second length of IR shutter 230 corresponding to a second length of display 240. The patterns of rows R1-R6 may also be overlayed and merged, if desired. As an example, IR shutter 230 may display the pattern of row R1 overlayed with the pattern of row R3 in a given length of IR shutter 230 corresponding to a given length of display 240.

FIG. 4 illustrates an IR light emitting display system 400 that uses a non-transmissive display element 440. Display system 400 may replace, or be used in conjunction with, display module 202 of FIG. 2. Display element 440 may be an LED or OLED display element. Display element 440 may include display driver circuitry 441 that controls display pixels 442. Display pixels 442 may be visible light display pixels or IR pixels. As an example, display pixels 442-1, 442-2, and 442-3 may be visible light display pixels that emit visible light 443; display pixel 442-4 may be an IR pixel that emits IR light 444. An IR illumination source 428 may be formed over one or more display pixels such as 442-N. IR illumination source 428 may be covered by an optical masking layer 451.

IR illumination source 428 may emit IR light 224. IR light 224 may be directed toward an IR dispersive element 424 that couples or directs input IR light 224 to output light 445. IR dispersive element 424 may include multiple light guide elements that direct input IR light 224 to output light 445. IR dispersive elements 424 may be transparent to broad spectrum or visible light. Alternatively, IR dispersive elements 424 may interfere with visible light emitted by certain display pixels 442. Display driver circuitry 441 may modulate the signals powering display pixels 442 to compensate for the interference of IR dispersive element 424 with visible light 443 and/or IR light 444 emitted from display pixels 442.

IR shutter 430 may be formed above or over IR dispersive element 424. IR shutter 430 may be controlled to modulate the IR light transmittance of regions 431 and 432. The area of regions 431 and 432 may correspond to the area of display pixels 442. The area of regions 431 and 432 may alternatively be larger or smaller than the area of display pixels 442. Regions 431 of IR shutter 430 may be configured by control circuitry included in display driver circuitry 441 to allow transmittance of IR light 445P. Regions 432 may be configured by the control circuitry to attenuate or block transmittance of IR light 445B. Visible light 443 emitted from display pixels such as 442-1, 442-2, and 442-3 may be transmitted through regions 431 and 432. IR light 444 emitted from a display pixel such as 442-4 may be blocked by regions 432. IR shutter 430 may be controlled to allow IR light in any of the patterns, combination of patterns, or overlay of patterns represented by the patterns of rows R1-R6 of FIG. 3.

In an embodiment, IR illumination source 428, optical masking layer 451, and IR dispersive element 424 may be omitted from display system 400, and IR shutter 430 may be formed above the display pixels 442 without intervening IR dispersive element 424. In the embodiment where IR illumination source 428, optical masking layer 451, and IR dispersive element 424 are omitted from display system 400, the IR shutter 430 may extend above all display pixels 442. IR shutter 430 may alternatively extend above only a subset of display pixels 442. When IR shutter 430 is formed over display pixels 442 without an intervening IR dispersive element 424, IR display pixels such as 442-4 may be controlled by display driver circuitry 441 to output structured light patterns similar to those shown in FIG. 3 above. Alternatively or additionally, IR shutter 430 may be configured by control circuitry in display driver circuitry 441 to filter the light from IR display pixels such as 442-4 I certain regions, such as regions 432 when IR shutter 430 is formed above display pixels 442 to produce output structured light patterns similar to those shown in FIG. 3.

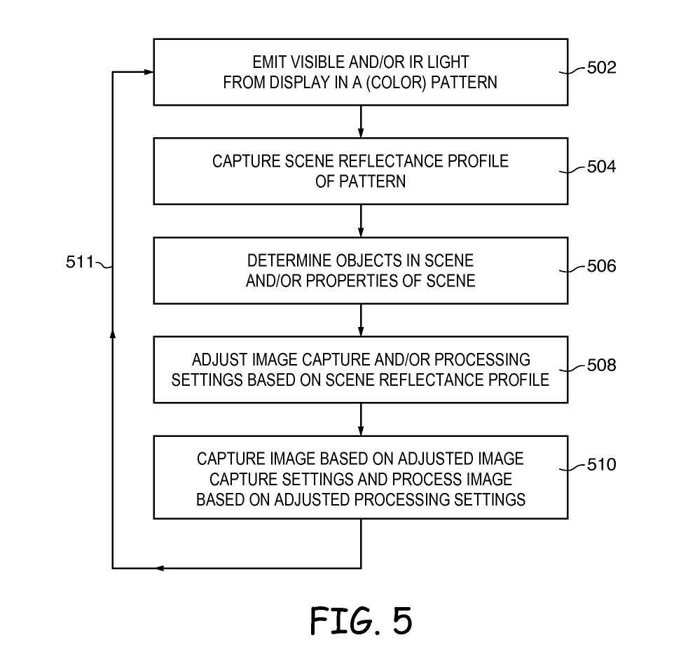

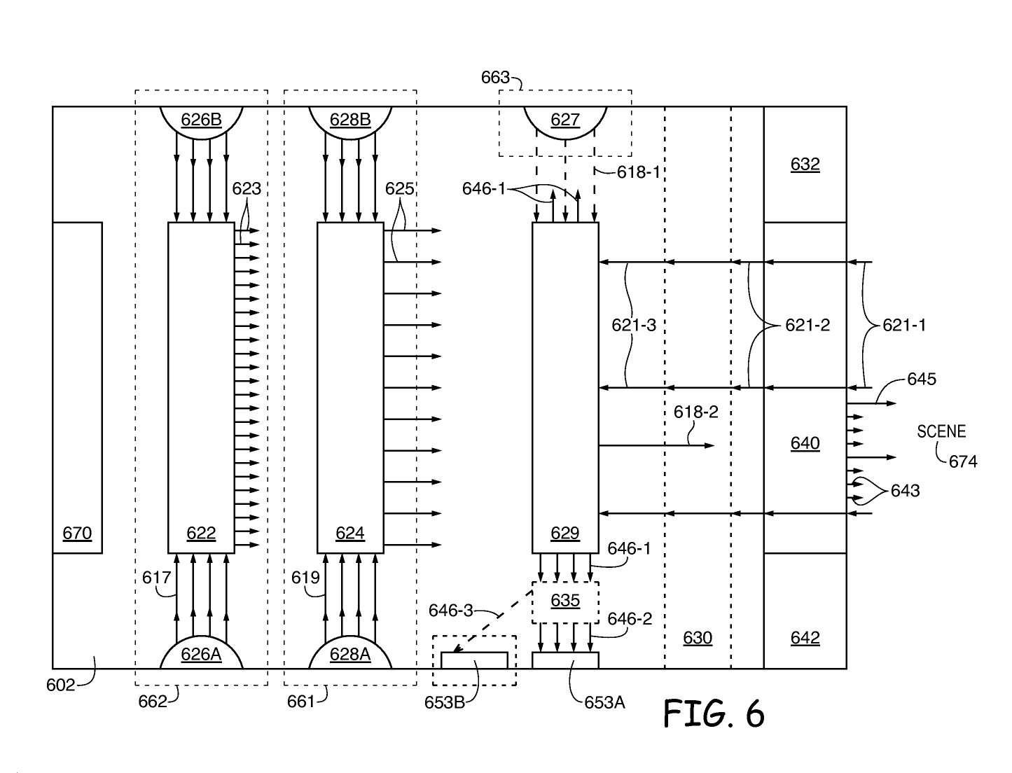

FIG. 5 is a flow chart of steps that may be used in operating a system 200 with a display module 202 (as shown in FIG. 2), a display system 400 (as shown in FIG. 4), and/or an integrated camera display module 602 (described in greater detail below in connection with FIG. 6). At step 502, the display may emit visible and/or IR light from a display in a desired pattern.

In the example of display module 202, step 502 may correspond to activating broad spectrum illuminants 226/626 and/or IR illuminants 228/628. Step 502 may further include controlling IR shutter 230/630 using shutter control 232/632 to selectively transmit output IR light 225/625 in one or more patterns or combinations of structured light patterns of FIG. 3 as displayed IR light 245. Step 502 may also include controlling display 240/640 using display driver 242/642 to filter broad spectrum output light 223/623 in a color pattern that is output and represented by displayed visible light 243.

In the example of display system 400, step 502 may correspond to using display driver circuitry 441 to provide power and/or control signals to display pixels 442 to produce a color pattern to be output. Step 502 may further include activating IR illuminant 428 and controlling IR shutter 430 to selectively allow transmission of IR light 445P from IR dispersive element 424 in regions 431 and to selectively block IR light 445B from IR dispersive element 424 in regions 432. IR shutter 430 may be controlled to emit IR light in one or more patterns or combinations of patterns of FIG. 3.

At step 504, image sensors (e.g., sensors 14) on cameras 253/653 may capture a scene reflectance profile of the emitted visible and/or IR pattern. For example, cameras 253/653 may capture a visible and/or IR image of the scene while the pattern is being emitted in step 502. If desired, cameras 253/653 may capture time-of-flight data for displayed visible light 243 and/or displayed IR light 245.

At step 506, processing circuitry 16/24 may identify objects in the scene and/or properties of the scene based on the captured scene reflectance profile (e.g., based on the captured images). When an image corresponding to visible light reflected by the scene is captured in step 504, knowledge of the color pattern of the displayed visible light 243 can be used to distinguish between different objects in the scene, and optical characteristics of objects. When an image corresponding to IR light reflected by the scene is captured in step 504, knowledge of the structured IR light pattern of the displayed IR light 245 can be used to distinguish between different objects in the scene, and IR/thermal characteristics of objects. If desired, the processing circuitry may use depth mapping techniques to distinguish between different objects in the scene using a visible image, visible light time-of-flight data, an IR image capturing reflected structured light patterns, or IR time-of-flight data.

At step 508, processing circuitry 24 may adjust image capture and/or image processing settings based on the scene reflectance profile pattern. In step 508, image capture settings used by cameras 253/653 to capture images may be adjusted based on the scene reflectance profile captured in step 504 and the objects/properties of the scene determined in step 506. As an example, the integration time of pixels, color gain registers, or lens focus settings (i.e. image capture settings) in cameras 253/653 may be adjusted based on the depth of objects or object reflectance determined in step 506. Image processing settings, such as auto white balance matrices and gamma correction may be adjusted based on object depth and/or reflectance data calculated in step 506.

At step 510, cameras 253/653 may capture an image using the adjusted image capture settings and processing circuitry 24/16 may process the captured image based on the adjusted image processing settings. For example, cameras 253/653 may capture a visible and/or IR image using the adjusted image capture settings determined in step 508. In a video capture mode, transition 511 may be used to loop back to step 502 after capturing an image in step 510.

FIG. 6 illustrates a cross-sectional side view of an integrated camera display module 602. The outline of integrated camera display module 602 may represent a device housing. Transmissive display element 640 may be a color or monochrome LCD display. Display 640 may be any type of transmissive display element. Display 640 may be able to display color images. Display 640 may be transparent to infrared (IR), or near-infrared light when displaying color patterns or forms. Alternatively, when color patterns or forms are displayed, display 640 may be opaque to IR or near-IR light.

Backlight illumination sources 626 and 628 may be formed behind display 640, at the edges of integrated camera display module 602. A given backlight illumination source may be formed at one or more edges of integrated camera display module 602 behind display 640. Broad spectrum illumination source 626A may be formed at a first edge of integrated camera display module 602 behind display 640, whereas another broad spectrum illumination source 626A may be formed behind display 640 at a second edge of integrated camera display module 602 that is opposite the first edge. In embodiments of the present invention, a single broad spectrum illumination source such as 626A or 626B may be used, two broad spectrum illumination sources such as 626A and 626B may be used, or more than two broad spectrum illumination sources may be used. Broad spectrum illumination sources may be placed at opposing edges of an integrated camera display module 602 or at adjacent edges of a integrated camera display module 602.

Broad spectrum light 614 emitted from broad spectrum illumination sources 626 may enter a broad spectrum dispersive element 622. Broad spectrum dispersive element 622 may include a number of light guide elements that couple input broad spectrum light 614 to output broad spectrum light 623 with a uniform luminance or intensity across the area of broad spectrum dispersive element 622. Output broad spectrum light 623 may be of a uniform luminance and intensity. Broad spectrum dispersive element 622 may include additional light guide components 252 that help couple or direct input broad spectrum light 614 to output broad spectrum light 623.

Light 623 output from broad-spectrum dispersive element 622 may be used to illuminate the contents of dispersive display element in display 640. Broad spectrum illumination sources 626 may output light corresponding to the visible spectrum. Broad spectrum illumination sources 626 may produce broad spectrum light 614 which may correspond to white light. Output broad spectrum light 623 from broad spectrum dispersive element 622 may have substantially the same spectral characteristics as broad spectrum light 614 produced by broad spectrum illumination sources 626. Output broad spectrum light 623 may be white light.

Output broad spectrum light 623 may pass through infra-red dispersive element 624 and IR shutter 630 (described below) to display 640. Broad-spectrum dispersive element 622 may be configured to output broad spectrum light 623 in an even and constant intensity and/or luminance when infrared dispersive element 624 minimally interferes with output broad spectrum light 623. When the interference of infrared dispersive element 624 with output broad spectrum light 623 is noticeable, output broad spectrum light 625 coupled via broad spectrum dispersive element 622 from input broad spectrum light 614 produced by broad spectrum illuminants 626 may have a non-uniform luminance and/or intensity across the area of broad spectrum dispersive element 622. The pattern or intensity of output broad spectrum light 623 may be unevenly distributed in a manner such that after passing through infra-red dispersive element 624, the broad spectrum light 623 may be of a uniform intensity and/or luminance in the area of display 640.

Output broad spectrum light 623 may serve as a backlight for transmissive display elements in display 640. Output visible light 643 may be color light that corresponds to output broad spectrum light 623 that has been filtered by transmissive display elements in display 640, such as LCD elements. Output visible light 643 may correspond to the light of colors and forms displayed on display 640.

Integrated camera display module 602 may additionally include infrared (IR) or near infrared (NIR) illumination sources 628. In descriptions IR or NIR light being emitted or received from components in embodiments of the present invention, the terms IR and NIR may be used interchangeably and may refer to light in both IR and NIR spectra.

NIR illumination source 628A may be formed at a first edge of integrated camera display module 602 behind display 640, whereas another NIR illumination source 628A may be formed behind display 640 at a second edge of integrated camera display module 602 that is opposite the first edge. In embodiments of the present invention, a single NIR illumination source such as 628A or 628B may be used, two NIR illumination sources such as 628A and 628B may be used, or more than two broad NIR sources may be used. IR illumination sources may be placed at opposing edges of a integrated camera display module 602 or at adjacent edges of a integrated camera display module 602.

IR light 619 emitted from NIR illumination sources 628 may enter an IR dispersive element 624. IR dispersive element 624 may include multiple light guide elements that couple input IR light 619 to output IR light 625 with a uniform luminance or intensity across the area of dispersive element 624. Output IR light 625 may be of a uniform luminance and intensity. IR dispersive element 624 may include additional light guide components 254 that help couple or direct input IR light 619 to output NIR light 625. The luminance or intensity of output NIR light 625 may be less than or equal to the luminance or intensity of output broad spectrum light 625 from broad spectrum dispersive element 622. IR light 619 emitted from broad spectrum illumination sources 628 may be constantly emitted, or emitted periodically for finite intervals of time. Consequently, output IR light 625 may be constantly produced, or produced periodically for finite intervals of time.

As described above, IR dispersive element 624 may couple input IR light 619 to produce output IR light 625 that is more sparse, or less dense, than the output broad spectrum light 623 from broad spectrum dispersive element 622. However, output IR light 625 may have the same or greater intensity and/or luminance as output broad spectrum light 623.

An IR shutter 630 may be formed between infrared dispersive element 624 and display 640. IR shutter 630 may be transparent to broad spectrum light 623. IR shutter 630 may include an IR transmissive material that can be configured or controlled to reduce transmittance of IR light in certain regions. IR shutter 630 may be transparent to output broad spectrum light 623 and output IR light 625 in a default state. IR shutter 630 may be activated to selectively block IR light 625 from transmission through display 640 when NIR illumination sources 628 are turned on and emitting input IR light 619. Shutter control 632 may be used to control which regions of IR shutter 630 are configured to reduce transmittance, or block, output IR light 625. IR shutter 630 may be configured to pass IR light in any of the patterns or combinations of patterns described above in connection with FIG. 3.

Different portions of IR shutter 630 may reduce transmittance of output IR light 625 by varying degrees. For example, a first region of IR shutter 630 may reduce transmittance of output IR light 625 by 50 percent whereas a second region of IR shutter 630 may reduce transmittance of output IR light 625 by 25 percent. Alternatively, IR shutter 630 may have binary states for blocking or allowing transmission of output IR light 625 (i.e. 0 percent or 100 percent transmission, respectively). An idle state of IR shutter 630 may correspond to a state wherein all light (broad spectrum and IR) passes through IR shutter 630.

Display 640 may be transparent to IR light 625, and only filter output broad spectrum light 623. In this way, display 640 may be used to display color forms illuminated by output broad spectrum light 623. Alternatively, regions of display 640 from which it is desired to output IR light 625 may be configured to be in an idle state (i.e. allow transmission of output broad spectrum light 623) in the region, or configured to be in a dark state (i.e. block transmission of output broad spectrum light 623) in the region. Display driver 642 may control multiple regions of transmissive display element 640 filter to filter particular colors from output broad spectrum output light 623. Display driver 642 may be a color or monochrome LCD display driver.

Light transmitted through display 640 may correspond to displayed visible light 643 and displayed IR light 645. Displayed IR light 645 may correspond to output IR light 625 filtered by IR shutter 630, and/or display 640. Displayed visible light 643 may correspond to output broad spectrum light 623 that may be dispersed by infrared dispersive element 624 and/or filtered by display 640. IR shutter 630 may be in an idle state when it is desired to display visible light 643 to a user. Alternatively, IR shutter 630 may be transparent to broad spectrum light while blocking IR light and be in any state when it is desired to display visible light 643 to a user.

To avoid obscuring the novel features of the integrated camera display module 602, displayed broad spectrum light 643 and displayed IR light 645 are shown being produced from only a portion of the area of display 640. However, this is merely illustrative. If desired, displayed broad spectrum light 643 and displayed IR light 645 may be emitted from the entirety of the area of display 640.

Broad spectrum illuminant 662 and broad spectrum dispersive element 222 are pictured as being located in region 662, with IR illuminant 628 and IR dispersive element 624 located in region 661 between region 662 and display 640. However, this is merely illustrative. Broad spectrum illuminant 662 and broad spectrum dispersive element 222 may be located in region 661 between region 662 and display 640; in this configuration, IR illuminant 628 and IR dispersive element 624 may be omitted or excluded from integrated camera display module 602, or located in region 662. If IR illuminant 628 and IR dispersive element 624 are excluded from integrated camera display module 602, IR shutter 630 may also be excluded.

Between region 661 and the display 640, a dispersive element 629 may be formed. Dispersive element may be configured to couple light 621-1 incident on display 640 that passes through display 640 as light 621-2 and through IR shutter 630 as light 621-3, to be output as light 646-1. Light 646-1 may be directed toward an optional optical elements 655. Optical elements 655 may include a beam splitter that splits light 646-1 into light 646-2 and 646-3. Light 646-2 and light 646-3 may be directed toward image sensors 653A and 653B, respectively. Image sensor 653A and 653B may include pixel arrays of image pixels with color filter arrays, image pixels with IR filters, time-of-flight pixels with color filter arrays, and time-of-flight pixels with IR filters.

Dispersive element 629 may also couple light 618-1 from an illuminant 627 to be output as light 618-2. Illuminant 627 may be a broad spectrum illuminant or an IR illuminant. Light 618-1 and 618-2 may be broad spectrum light or IR light. Illuminant 627 may be placed at the edge of integrated camera display module 602 in region 663. Illuminant 627 may be omitted or excluded from the edge region 663 of integrated camera display module 602, and replaced with an additional image sensor similar to image sensor 653.

Broad spectrum light 623 and (optionally) 618-2 may interfere with light 621-1 incident on display 640. Active states (i.e. non-idle states) of display 640 may interfere with, or filter incident light 621-1 resulting in modified light 621-2. Modified light 621-2 may be different than incident light 621-1 if incident light 621-1 is visible spectrum light. If light 621-1 is IR light or any light outside the visible spectrum, modified light 621-2 may be the same as incident light 621-1 in active states of display 640. Active states (i.e. non-idle states) of IR shutter 630 may interfere with, or filter light 621-2 to produce modified light 621-3. Modified light 621-3 may be different than light 621-2 if light 621-2 is IR spectrum light. If light 621-2 is outside the IR spectrum, light 621-3 may be the same as light 621-2 in active states of IR shutter 630. It may be desirable, in certain embodiments of the present invention, to configure display 640 and/or IR shutter 630 in active states during an image capture mode of integrated camera display module 602.

As described above, light 621-3 may be coupled to light 646-1 via dispersive element 629. Dispersive element 629 may be an IR dispersive element or a broad spectrum dispersive element. However, an image corresponding to light from 621-1 or 621-3 may not be identical to an image corresponding to light 646-1, due to the dispersion pattern of dispersive element 629. An image captured by image sensors 653 may require image processing to better approximate the light 621-1 incident on the display, or even the light 621-3 incident on the dispersive element 629. Such image processing may include computationally deconstructing the influence of dispersive element 629 on light 621-3 to produce light 646-1. Computationally deconstructing the influence of dispersive element 629 may include applying a transformation to an image captured by image sensors 653 corresponding to a deconstructed or reverse transform corresponding to a transformation profile of dispersive element 629.

The transformation profile of dispersive element 629 may correspond to a transformation pattern exhibited by dispersive element 629 in response to incident light. Dispersive element 629 may have a visible light transformation pattern. Dispersive element 623 may have an IR light transformation pattern that is different than the visible light transformation pattern. The transformation profile of dispersive element 629 may be a transfer function which describes how an image formed by light 621-3 is transformed as it is optically coupled to light 646-1. This transformation profile may be modeled as a mapping between input image light that is incident on the dispersive element 629 as light 621-3 and output image light 646-1. The transformation profile of dispersive element 629 may be a spatial transfer function, an optical transfer function, modulation transfer function, phase transfer function, contrast transfer function, modulation transfer function, or coherence transfer function of dispersive element 629. The reverse transform may transform image signals captured by image sensors 653 to represent the light incident on screen 621-1 and/or light 621-3. Applying the reverse transform may include matrix multiplication, and/or matrix inversion operations with dedicated matrix multiplication and/or matrix inversion circuitry in control and processing circuitry 670.

Dispersive element 629 may be associated with a first transformation function related to how visible light components in light 621-3 are modified when coupled to light 646-1. Applying the reverse transform may include applying an inverse transformation to the first transformation function to visible light signals captured by image sensors 653. Dispersive element 629 may be associated with a second transformation function related to how IR light components in light 621-3 are modified when coupled to light 646-1. Applying the reverse transform may include applying an inverse transformation to the second transformation function to IR light signals captured by image sensors 653.

Additionally or alternatively, IR shutter 630 may be configured in an active state corresponding to an inverse transform pattern that interferes with or filters IR light included in light 621-2 to produce modified light 621-3 that is coupled to light 646-1. Light 646-1 produced from modified light 621-3 may be captured by image sensors 653, and correspond to an image equivalent to an image based on light 621-2. In other words, a reversal of the light transformation caused by dispersive element 629 may be effected by a particular active configuration of IR shutter 630, instead of or in addition to applying a reverse transform to image data captured by image sensors 653.

Similarly, display 640 may be configured in an active state corresponding to an inverse transform pattern that interferes with or filters visible light included in light 621-1 to produce modified light 621-2 that is coupled to light 646-1. Light 646-1 produced from modified light 621-2 may be captured by image sensors 653, and correspond to an image equivalent to an image based on light 621-1. In other words, a reversal of the light transformation caused by dispersive element 629 may be effected by a particular active configuration of display 640, instead of or in addition to applying a reverse transform to image data captured by image sensors 653.

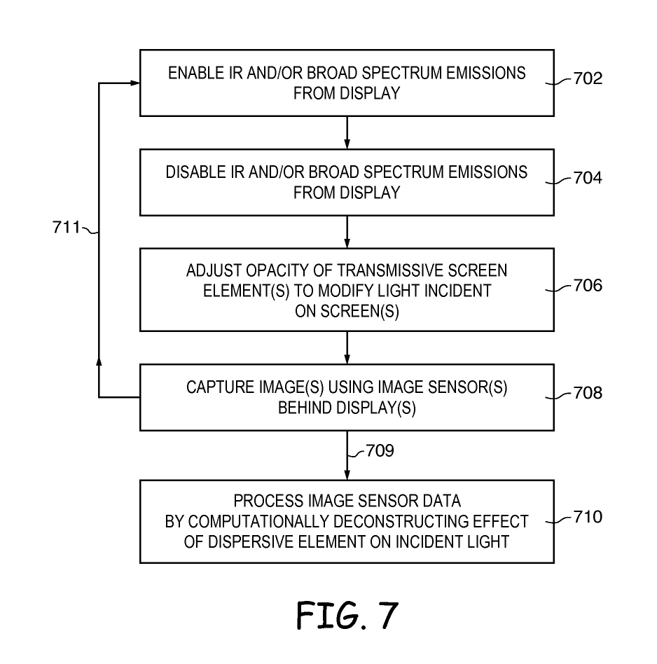

FIG. 7 illustrates steps used to operate and capture images using integrated camera display module 602. At step 702, control and processing circuitry 670 may enable IR and or broad spectrum emissions from display.

Step 702 may correspond to enabling IR illuminants 628, broad spectrum illuminants 626, and/or illuminant 627 which may be an IR illuminant or a broad spectrum illuminant. Light from IR illuminant 628 may be input to IR dispersive element 624 and output as light 625, and then filtered and/or selectively blocked by IR shutter 630, before passing through display 640 and corresponding to displayed IR light 645. If illuminant 627 is an IR illuminant, light 618-1 may be input to dispersive element 629 and output as light 618-2, and then filtered and/or selectively blocked by IR shutter 630, before passing through display 640 and corresponding to displayed IR light 645. Light from broad spectrum illuminant 626 may be input to broad spectrum dispersive element 622 and output as light 623, and then filtered and/or selectively blocked by display 640, before passing through display 640 and corresponding to displayed visible light 643. If illuminant 627 is a broad spectrum illuminant, light 618-1 may be input to dispersive element 629 and output as light 618-2, and then filtered and/or selectively blocked by display 640, then corresponding to displayed visible light 643.

At step 704, control and processing circuitry 670 may disable IR and/or broad spectrum emissions from display. Step 704 may correspond to disabling illuminants 626-628.

At step 706, control and processing circuitry 670 may adjust the opacity of transmissive screen elements such as display 640 and IR shutter 630 to modify light 621-1 incident on display 640. As described above, IR shutter 630 and/or display 640 may be configured in an active state to interfere with or filter IR and visible light respectively, to reverse the transformation of light caused by dispersive element 629, and thereby make light 646-1 output from dispersive element 629 correspond to light 621-1 incident on display 640.

At step 708, image sensors 653 behind display 640 in integrated camera display module 602 may capture images. Image sensors 653 may include pixels with color filters, pixels with IR filters, time-of-flight pixels with color filters, or time-of flight pixels with IR filters.

Transition 711 may be used to loop back to step 702 after capturing an image. The IR and/or broad spectrum emissions 645 and 643 from the display 640 may be enabled after step 708. The duration of steps 704, 706, 708 may be short enough that the period between successive transitions 711 is imperceptible to human eyes.

At step 710, control and processing circuitry 670 may processes image sensor data by computationally deconstructing the effect of dispersive element 629 on incident light 621-3. At step 708, control and processing circuitry 670 may apply a transformation to an image captured by image sensors 653 corresponding to a deconstructed or reverse transform corresponding to a transformation profile of dispersive element 629. The reverse transform applied by control and processing circuitry 670 may transform image signals captured by image sensors 653 to represent the light incident on screen 621-1 and/or light 621-3. Applying the reverse transform may include matrix multiplication, and/or matrix inversion operations with dedicated matrix multiplication and/or matrix inversion circuitry in control and processing circuitry 670. Transition 709 may lead to step 710 at any time, regardless of whether or not illuminants 626-628 are enabled in step 702.

Various embodiments have been described illustrating systems with embedded data transmission capabilities. A display module in a housing may have infra-red light emitting capabilities. The display module may include a transmissive display element. A broad spectrum illuminant may be formed at an edge of the display module housing that emits light that is optically coupled to the display element using a broad spectrum dispersive element. An IR illuminant may be formed at an edge of the display module housing. The IR illuminant may emit IR light. IR light emitted by the IR illuminant may be optically coupled to a display element using an IR dispersive element inside the housing of the display module. The IR dispersive element may be interposed between the broad spectrum dispersive element and the display element. IR light that is optically coupled to the display element may pass through the display element onto a scene. Light from the IR illuminant may be optically coupled via the IR dispersive element to the display element in a structured light pattern.

An IR shutter may be interposed between the IR dispersive element and the display element in an embodiment. The IR shutter may be operable in an active mode and an idle mode. Control circuitry may configure selected regions of the IR shutter to block IR light when the IR shutter is in the active mode. The IR shutter may be configured by control circuitry to selectively block light produced by the IR dispersive element so that the light that is passed through the IR shutter is a structured light pattern.

An image sensor may be formed at an edge of the housing. The image sensor may receive light that is optically coupled from light incident on the transmissive display element using a broad spectrum or IR dispersive element. Optical elements such as a light guide or a beam splitter may be interposed between the broad spectrum or IR dispersive element. The broad spectrum or IR dispersive element may exhibit a transformation profile such which may be modeled as a transfer function. Processing circuitry may apply an inverse transform to images captured using the image sensor, corresponding to the inverse of the transformation profile of the broad spectrum or IR dispersive element.

Images may be captured using image sensors inside the display module housing or outside the display module housing. Images of a scene may be captured, where a scene is also illuminated by IR or visible light emitted from illuminants inside the display module housing. A broad spectrum illuminant may emit broad spectrum light that is optically coupled to a display element that is configured by control circuitry to filter certain wavelengths of light in certain regions of the display element (e.g. a color display). The output color pattern may be incident on a scene which is then imaged using an image sensor in a camera. An IR illuminant may emit IR light that is optically coupled to an IR shutter that is configured by control circuitry to filter IR light in certain regions of the IR shutter. The output IR light pattern may be incident on a scene which is then imaged using an image sensor in a camera. An image of the scene may be captured while the output color pattern and or IR light pattern is incident on the scene. An image sensor may capture a scene reflectance profile of the scene.

Image processing circuitry may be used to determine objects in the scene and/or properties of the scene based on the scene reflectance profile. Image processing circuitry may distinguish between different objects in the scene, or may determine optical and/or IR characteristics of the objects. Image processing circuitry may also be used to process the captured image using depth mapping algorithms.

Based on the captured image, image capture settings and/or image processing settings may be adjusted. Another image may be captured based on these adjusted image capture settings and processed using these adjusted image processing settings.

In another embodiment, an IR shutter may be formed over an IR dispersive element that is formed over a non-transmissive display element such as a LED or OLED display panel.

The foregoing is merely illustrative of the principles of this invention and various modifications can be made by those skilled in the art without departing from the scope and spirit of the invention. The foregoing embodiments may be implemented individually or in any combination.

What is claimed is:

1. A display module comprising:
a light source that emits infrared (IR) light;
a display element;
an IR shutter that receives the IR light emitted by the light source, wherein the IR shutter is operable in an active mode and an idle mode; and
control circuitry, wherein the control circuitry configures at least one of a plurality of regions of the IR shutter to block the IR light when the IR shutter is in the active mode.

2. The display module defined in claim 1, wherein the IR shutter is interposed between the light source and the display element, the display module further comprising:
a dispersive element interposed between the light source and the IR shutter, wherein the display element comprises a transmissive display element.

3. The display module defined in claim 2, wherein the display module is formed within a housing having a plurality of edges and wherein the light source comprises:
an illuminant located at an edge of the housing, wherein the dispersive element is configured to optically couple light from the illuminant to the display element.

4. The display module defined in claim 3, wherein the illuminant comprises an IR illuminant and wherein the dispersive element comprises an IR dispersive element, the display module further comprising:
a broad spectrum illuminant formed at an additional edge of the housing; and
a broad spectrum dispersive element that is configured to optically couple light emitted from the broad spectrum illuminant to the display element.

5. The display module defined in claim 3, further comprising:
an image sensor formed at an additional edge of the housing that is different from the edge of the housing, wherein the dispersive element is configured to optically couple scene light incident on the transmissive display element to the image sensor.

6. The display module defined in claim 5, further comprising:
a light guide interposed between the dispersive element and the image sensor.

7. The display module defined in claim 5, further comprising:
a beam splitter interposed between the dispersive element and the image sensor; and
an additional image sensor formed at the additional edge of the housing, wherein the beam splitter couples light from the dispersive element to the additional image sensor.

8. The display module defined in claim 1, wherein the display element comprises an active light-emitting display element with first and second pluralities of display pixels, wherein the first plurality of display pixels emit color visible light, wherein the second plurality of display pixels emit IR light, wherein the light source that emits IR light comprises the second plurality of display pixels.

9. The display module defined in claim 8, further comprising:
display driver circuitry that configures the second plurality of display pixels to emit structured IR light patterns.

10. The display module defined in claim 8, wherein the IR shutter is formed directly over the active light-emitting display element.

11. A method of operating an electronic device having an illuminant, a dispersive element, a display element, and an image sensor, the method comprising:
enabling the illuminant within the electronic device;
with the dispersive element, receiving light from a scene that passes through the display element in a first direction;
with the dispersive element, optically coupling the light to the image sensor so that the optically coupled light is incident upon the image sensor in a second direction that is perpendicular to the first direction; and
with the image sensor, capturing an image using the optically coupled light received from the dispersive element.

12. The method of operating the electronic device defined in claim 11, further comprising:
disabling the illuminant before capturing the image; and
configuring the display element to selectively filter the light from the scene that passes through the display element so that the light comprises a modified version of light incident on the display from the scene.

13. The method defined in claim 12, wherein the dispersive element exhibits a first transformation pattern for visible light, wherein the dispersive element exhibits a second transformation pattern for IR light and wherein configuring the display comprises:
configuring regions of the display element to selectively filter light in a given configuration, wherein the given configuration exhibits a third transformation pattern that is the inverse of the first transformation pattern; and
configuring regions of an IR shutter to selectively block IR light in an additional configuration, wherein the additional configuration exhibits a fourth transformation pattern that is the inverse of the second transformation pattern.

14. The method defined in claim 11, wherein capturing the image comprises:
with a beam splitter, splitting the optically coupled light into first and second portions of the optically coupled light;
with the image sensor, capturing the first portion;
with an additional image sensor, capturing the second portion; and
receiving light that passes through an IR shutter within the electronic device.

15. The method of operating an electronic device defined in claim 11, further comprising:
with processing circuitry, applying a reverse transform to the captured image, wherein the reverse transform comprises an inverse of an input transformation associated with the dispersive element.

16. A method of operating an electronic device having a display, first and second image sensors and an illuminant coupled to processing circuitry, the method comprising:
using light emitted from the illuminant, outputting patterned light through the display onto a scene;
with the first image sensor, capturing a first image of the scene after the patterned light is output using light from the illuminant;
with the processing circuitry, adjusting image capture settings based on the captured first image; and
with a second image sensor, capturing a second image of the scene using the adjusted image capture settings.

17. The method of operating an electronic device defined in claim 16, wherein the display comprises a planar display, wherein a first direction that is perpendicular to the plane of the display is associated with the planar display, and wherein the illuminant emits light in a second direction that is perpendicular to the first direction, the method further comprising:
with a dispersive element, optically coupling the light emitted from the illuminant so that the optically coupled light is output from the dispersive element in a third direction that is the same as the first direction.

18. The method of operating an electronic device defined in claim 16, wherein the illuminant comprises an IR illuminant, wherein the electronic device has control circuitry, and wherein outputting patterned light through the display further comprises:
using the control circuitry, configuring selected regions of an IR shutter to filter IR light emitted by the illuminant.

19. The method of operating an electronic device in claim 16, further comprising:
with the processing circuitry, adjusting image processing settings based on the first image; and
with the processing circuitry, processing the second image using the adjusted processing settings.

20. The method of operating an electronic device defined in claim 16, wherein outputting patterned light comprises:
outputting a first pattern overlayed by a second pattern, wherein the first and second patterns are each selected from the group consisting of: a speckled circle pattern, a horizontal slit pattern, a vertical slit pattern, and a grid pattern.
